(19) United States
(12) Patent Application Publication
(10) Pub. No.: US 2016/0237745 A1
(43) Pub. Date: Aug. 18, 2016

(54) A WINDOW SHADING CONTROL SYSTEM AND METHOD THEREOF BASED ON DECOMPOSED DIRECT AND DIFFUSE SOLAR RADIATIONS

(71) Applicant: PHILIPS LIGHTING HOLDING B.V., Eindhoven (NL)

(72) Inventors: YAO-JUNG WEN, CONCORD, CA (US); ROBERT D. CLEAR, BERKELEY, CA (US)

(73) Assignee: Philips Lighting Holding B.V., Eindhoven (NL)

(21) Appl. No.: 15/027,114

(22) PCT Filed: Sep. 29, 2014
(86) PCT No.: PCT/IB2014/064923

§ 371 Date: Apr. 4, 2016

Related U.S. Application Data
(60) Provisional application No. 61/886,221, filed on Oct. 3, 2013.

(51) Int. Cl. E06B 9/68; G01J 1/42; E06B 9/24

(52) U.S. Cl. CPC E06B 9/68; E06B 9/24; G01J 1/4204; E06B 2009/6827; G01J 2001/4266

(57) ABSTRACT

A window shading control system (100) includes a sensor (110) configured to produce a global radiation measurement for each direction of at least four directions, wherein each global radiation measurement is a combined direct and diffuse component of at least one of illuminance and irradiance; a processor (120) connected to the sensor and configured to compute a discrete direct component and a diffuse component for global radiation measurement; and a control circuit (130) connected to the processor and configured to control a window shading system (150) based on the discrete direct component and the diffuse component computed for at least one global radiation measurement.

The invention generally relates to the control of lighting, and shading, and more specifically to a controller having a flexible architecture to control the same.

In modern buildings electric lights and window shades are electronically controlled to create comfortable lighting conditions. Electric lights may be controlled by wall switches, or may be automatically dimmed or turned off in response to daylight and/or occupancy status. Shading systems, such as venetian blinds and roller shades, are motorized systems that can be controlled responsive to daylight, glare and/or an occupant's preferences.

Specifically, window shading systems are used to block glaring direct sun and regulate the indoor daylight level. The control of shade deployment level and/or blind occlusion not only impacts the visual comfort of occupants, it also impacts energy consumption. That is, if the shade or blind blocks more daylight than necessary, additional electric lighting energy may be required to provide general illumination. On the other hand, additional cooling energy may be consumed to offset the cooling load due to solar heat gain resulting from shades/blinds that are not properly adjusted. The shade deployment level is the percentage of a window area occluded due to the shade. The shade deployment level differs for different buildings and façades.

Automated shading systems often utilize a sky sensor to control the deployment of shades or the occlusion of blinds. The sensor may be mounted horizontally on the roof facing the sky, or on the window wall interior, or on the exterior of the controlled space. The sensor may be sensitive to visible light for detecting illuminance (daylight) or sensitive to the entire solar spectrum for detecting irradiance (solar heat flux). Regardless of the sensor's location and sensitivity, the sensor only outputs the combined effect of direct and diffuse illuminance or irradiances, typically referred to as global illuminance/irradiance.

In order to correlate a sky sensor's output signal (global illuminance/irradiance) to the presence of direct sunlight or the overall interior daylight condition, certain heuristic or complex calibration procedures should be utilized. These procedures usually result in thresholds that are outside a range which causes a full deployment of the shades or closing of the blinds. In other words, the presence of direct sunlight or excessive daylight is merely an inference, but not an actual measurement.

In the related art there are number of solutions for measuring direct and diffuse solar radiation. For example, in weather stations the direct normal irradiance value is measured using a pyrheliometer mounted on a solar tracker, and horizontal irradiance is measured by a pyrometer with a solar shading ring or band. These types of sensors are very expensive, thereby cost-prohibitive for shading control applications. Moreover, the measurements performed by the pyrheliometer and pyrometer sensors do not provide any information about the actual solar and lighting conditions experienced at each window.

Another solution for measuring the direct and diffuse solar radiation includes six silicon solar cells arranged in three pairs on three mutually perpendicular planes. One cell of each pair is exposed to both the direct rays of the sun and the diffuse light radiation incidental from the same direction, depending upon the orientation of the device and the time of day. The other cells of each pair are exposed only to the diffuse radiation on their respective planes. The differences in the measured radiation on each plane are squared, summed, and the square root of the sum is then taken to determine the actual value of the direct rays of the sun. Thus, this solution is designed to detect the presence of sunlight in the sky as further discussed in U.S. Pat. No. 4,609,288.

Yet another solar radiation sensor, discussed in the related art, is based on a plurality of light sensitive detectors and a masking element. The masking element has a pattern of translucent and opaque areas which are disposed to ensure that at any given time at least one detector can be exposed to direct sunlight (if the sun is shining) through a translucent area and at least one detector is shaded from direct sunlight by an opaque area. The light sensitive detectors lie in a horizontal plane of the radiation sensor. An exemplary implementation of such a sensor can be found in U.S. Pat. No. 6,417,500.

This solar radiation sensor is designed however, to merely detect the presence of sunlight in the sky and cannot provide sufficient information about the direct solar radiation that hits a window on a particular façade or the amount of diffuse radiation falling on a window. Therefore, the radiation sensors disclosed in the related art cannot be utilized in shading controller applications.

The main challenge when using a radiation sensor to control shades and/or blinds of a window shading system is that presently there is no easy way to distinguish the contribution of direct radiation from that of diffuse radiation. Direct sunlight is often undesirable on a task surface as bright patches of sunlight on the work surface (e.g., a desk, a computer screen, etc.) causes disturbing or even disabling glare, thereby preventing occupants from performing visual tasks. Diffuse daylight, on the other hand, is usually desirable for providing evenly distributed natural light on the work surface as long as the overall level is not unacceptably high.

With a single global light or radiation sensor, direct sunlight in front of a window has to be inferred through some calibration procedures. When the sensor reading exceeds a certain threshold, it is assumed that direct sun is present or that the overall light has reached an unacceptable level. In this case, the shade will be deployed or the blind will be closed in response. However, this threshold value can be achieved by many combinations of direct and diffuse light/radiation. Therefore, the shade/blind may be deployed or closed on a relatively bright day even without direct sunshine, thus obstructing an occupant's view to the outside and also resulting in suboptimal utilization of daylight for illumination.

Therefore, in recognition of the deficiencies of the prior art, it would be advantageous to provide a solution for controlling shading systems based on the decomposed direct and diffuse solar radiations.

Certain embodiments disclosed herein include a window shading control system. The system includes a sensor configured to produce a global radiation measurement for each direction of at least four directions, wherein each global radiation measurement is a combined direct and diffuse component of at least one of illuminance and irradiance; a processor connected to the sensor and configured to compute a discrete direct component and a diffuse component for global radiation measurement; and a control circuit connected to the processor and configured to control a window shading system based on the discrete direct component and the diffuse component computed for at least one global radiation measurement.

Certain embodiments disclosed herein also include a method for controlling a window shading system. The method comprises measuring a global radiation measurement for each direction of at least four directions, wherein each global radiation measurement is a combined direct and diffuse component of at least one of illuminance and irradiance; computing a discrete direct component and a diffuse component for the global radiation measurement; and controlling a window shading system based on the discrete direct component and the diffuse component computed for at least one global radiation measurement.

The disclosed subject matter is particularly pointed out and distinctly claimed in the claims at the conclusion of the specification. The foregoing and other features and advantages of the invention will be apparent from the following detailed description taken in conjunction with the accompanying drawings.

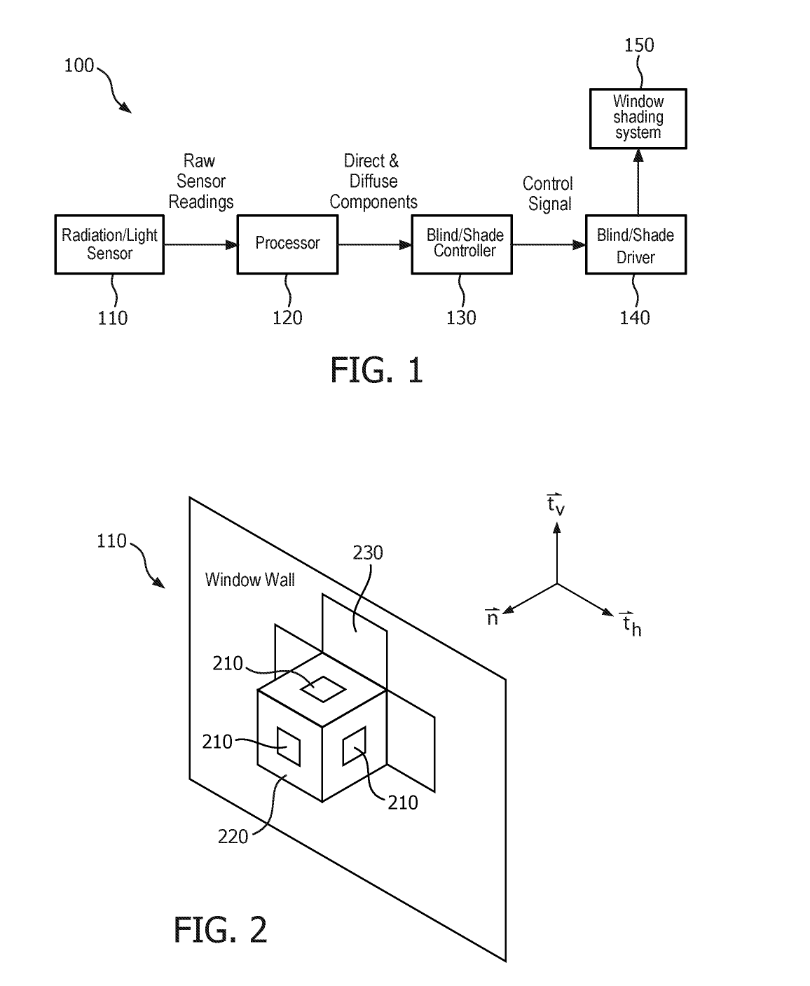

FIG. 1 is a schematic diagram of a window shading controller constructed according to one embodiment;

FIG. 2 is a schematic block diagram of a sensor designed to measure the direct and diffuse components of the solar radiation according to one embodiment;

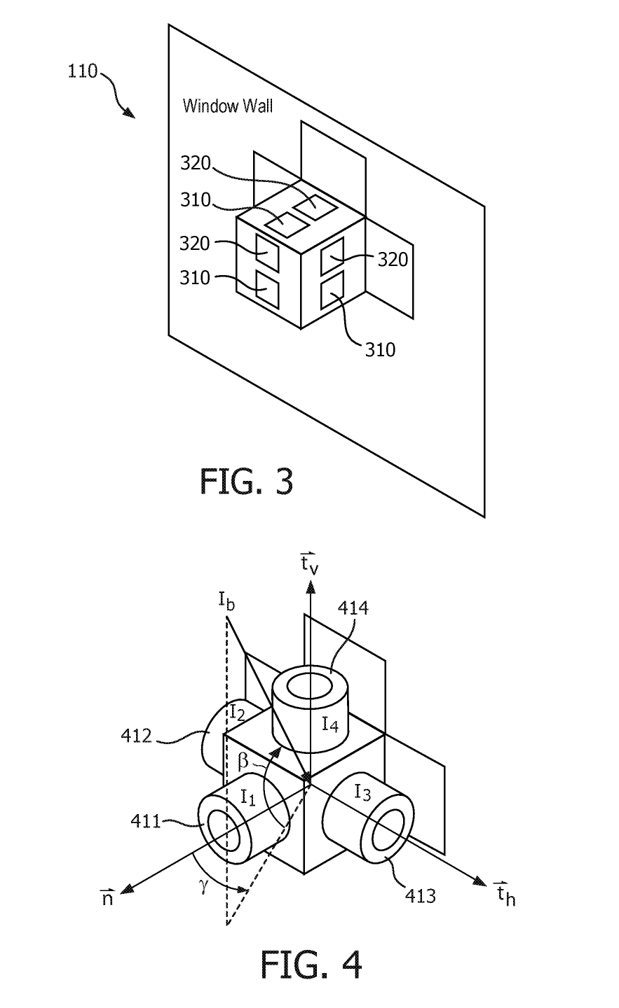

FIG. 3 is a schematic block diagram of a sensor designed to measure the direct and diffuse components of the solar radiation according to another embodiment;

FIG. 4 is a schematic block diagram illustrating how global radiation measurements are obtained by the sensor of FIGS. 2 and 3.

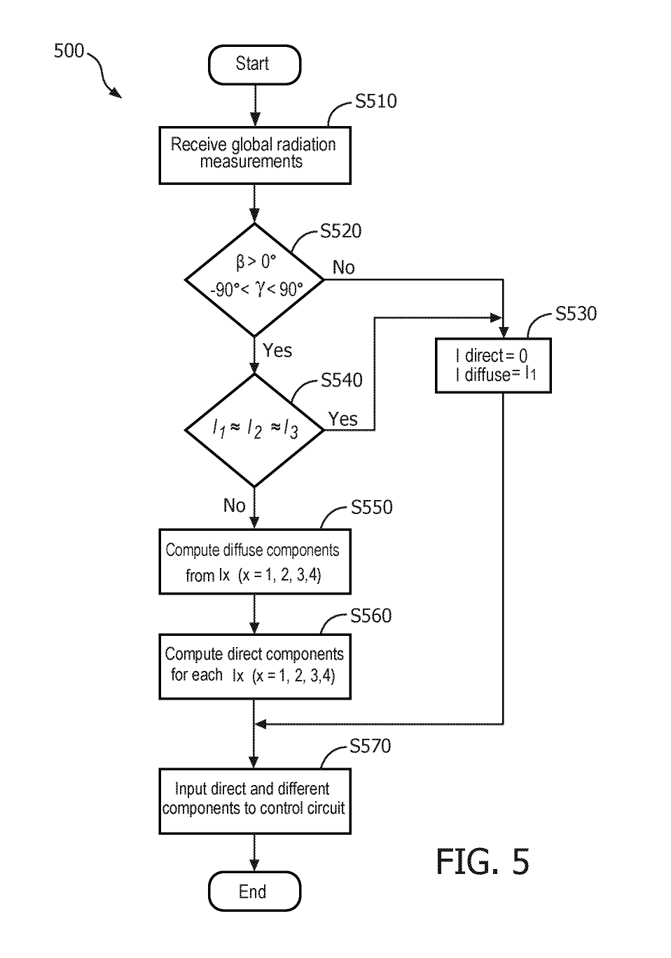

FIG. 5 is a flowchart illustrating a process for computing the diffuse and direct components of the solar radiation according to one embodiment; and

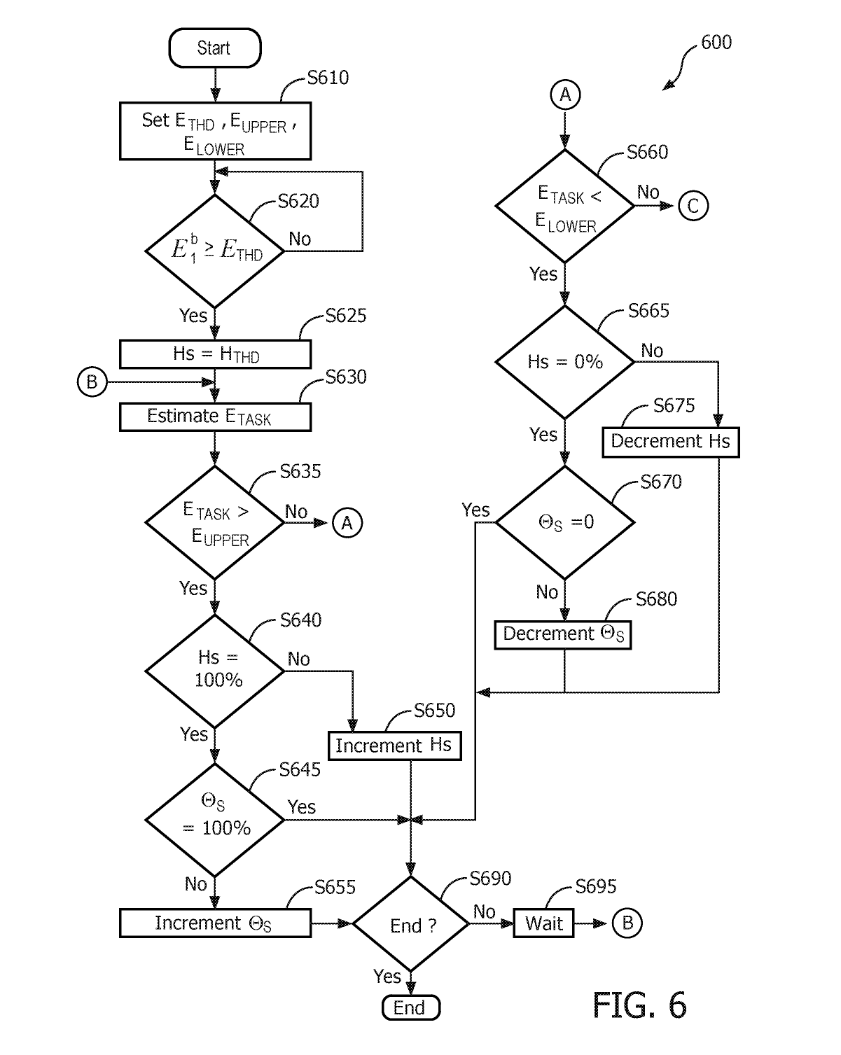

FIG. 6 is a flowchart illustrating a process for controlling of the shade/blind system using the diffuse and direct components of the solar radiation.

It is important to note that the embodiments disclosed are only examples of the many advantageous uses of the innovative techniques herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

Certain exemplary embodiments include a shading control system that controls a window shading system based on direct and diffuse solar radiation data decomposed from photosensitive elements. Also disclosed is a sensor comprised of a plurality of photosensitive elements arranged to allow obtaining the direct and diffuse components of at least one of illuminance (i.e., light) and irradiance (i.e., solar heat flux). In one embodiment, the sensor is mounted on a window wall, and hence “feels” the same amount of solar radiation as that which actually hits the window. Therefore, controlling the shades and blinds of the shading system, according to certain disclosed embodiments, facilitates accurate detection and prevention of direct sunlight as well as a better estimation of incoming daylight or solar heat gain. As a result, in certain embodiments the disclosed controller can actuate the shade or blind to optimize the indoor daylight and solar heat gain conditions.

FIG. 1 shows an exemplary and non-limiting block diagram of a window shading controller 100 constructed according to one embodiment. The integrated controller 100 includes a sensor 110, a processor 120, a control circuit 130, and a driver 140 driving the shades and blinds of a window shading system 150. The sensor 110 includes a plurality of photosensitive elements that are configured to measure direct and diffuse components of the illuminance, direct and diffuse components of the irradiance, or direct and diffuse components of both the illuminance and irradiance. The structure and configuration of the photosensitive elements of the sensor 110 are discussed in greater detail below.

The processor 120 is configured to compute the direct and diffuse components of the solar radiations measured by the sensor 110. Each photosensitive element in the sensor 110 returns a global radiation measurement of illuminance or irradiance, depending on the type of the photosensitive element. The global radiation measurement provided by a photosensitive element contains a combination of direct and diffuse components measured at the direction to which the photosensitive element is facing. The process for computing the direct and diffuse components is discussed in greater detail below.

The control circuit 130 is configured to adjust or set the shade deployment level and the blinds occlusion level in the system 150 based on the input provided by the processor 120, i.e., the computed direct and diffuse components. As will be discussed below, according to one embodiment, the control circuit 130 can iteratively adjust the deployment and occlusion levels of the shade and blinds until achieving comfortable lighting conditions for the occupant.

The driver 140 is configured to power and control the electrical components of the window shading system 150. For example, the driver 140 is configured to control the motors (not shown) controlling the movement of the shades and blinds in the system 150.

FIG. 2 is an exemplary and non-limiting diagram of the sensor 110 designed to measure the direct and diffuse components of the illuminance and/or irradiance according to one embodiment. The sensor 110 in the embodiment illustrated in FIG. 2 includes a plurality photosensitive elements, collectivity labeled as 210, a housing 220 to enclose the photosensitive elements 210 as well as any auxiliary circuitry (not shown), and reflection blockers collectivity labeled as 230. The sensor 110 is designed to be mounted on the same side of a façade as the window shades/blinds. The sensor 110 can be mounted by means of glue, screws, or any other fastening means.

Each photosensitive element 210 can be either sensitive to visible light and/or the entire spectrum of solar radiation. In one embodiment, an element 210 can comprise two photodiodes, where one has the spectral response of visible light and the other has the spectral response of solar radiation.

As noted above the sensor 110 can be configured to measure the visible daylight level (illuminance), the solar radiation level (irradiance), or both. In any configuration, both the diffuse and direct components may be measured. In order to measure the visible daylight level, i.e., illuminance, all the photosensitive elements 210 have the spectral response of a Commission Internationale de l'Éclairage (CIE) luminosity function with a similar sensitivity to that of human eyes.

To measure the heat flux from the solar radiation level, i.e., irradiance, the sensor 110 is configured to include photosensitive elements 210 with a spectral response that is relatively flat across all wavelengths. In the case where both illuminance and irradiance are required, for example, for simultaneously estimating daylight level and solar heat gain, the sensor 110 is configured to include two different types of photosensitive elements 210 installed on each of the four faces of the sensor housing 220. An exemplary diagram of such a sensor is provided in FIG. 3.

In the exemplary FIG. 3, the photosensitive elements 310 measure the direct and diffuse components of the illuminance and have a response function as described above. The photosensitive elements 320 measure the direct and diffuse components of the irradiance and have a response function as described above. It should be noted that in FIGS. 2 and 3, only 3 faces of the 6 faces of the sensor housing 220 are shown. It should be further noted that a typical sensor 110 includes 4 (or 4 pairs) of photosensitive elements.

Referring back to FIG. 2, in one embodiment the enclosure of the sensor housing holds the photosensitive elements 210 in their predefined positions and seals the auxiliary circuitry within the housing. The auxiliary circuitry is used for amplifying the signals produced by the photosensitive elements 210, to allow proper reading of such signals by the processor 120. It should be noted that as the photosensitive elements 210 can be standard photodiodes, the dimensions of the sensor 110 can be relatively compact in size. The reflection blockers 230 are flanges designed to absorb light and/or radiation to prevent the photosensitive elements 210 from seeing the light and/or radiation reflected from the building surface.

The operation of the sensor 110 will now be described with reference to FIG. 4. Four photosensitive elements 411, 412, 413, and 414 are included in the sensor 110 providing a global radiation measurement I₁, I₂, I₃, and I₄ respective of illuminance or irradiance. The sensor 110 is mounted on a façade surface in such a way that element 411 is facing out of the building (i.e. perpendicular to the façade) and measures incident radiation normal to the façade. The photosensitive elements 412 and 413 measure radiation projected onto the horizontal plane and are parallel to the façade. The photosensitive element 414 measures radiation from sky zenith. Each measurement I₁, I₂, I₃, and I₄ includes both the combined direct and diffuse components of either the illuminance or irradiance. The vector I_{b} shown in FIG. 4, is the direct normal solar radiation. The angles β and γ are the solar altitude and the solar elevation azimuth angles respectively, that is, the angle between the sun and the façade surface normally projected onto the horizontal plan. The angles β and γ can be computed using location and time information. For example, the solar altitude angle β and the solar elevation azimuth angle γ can be computed as follows:

$$y = α - e$$

$$tan ( α ) = \frac{- {sin ( H )}^{*} cos ( D )}{- ( {cos ( L )}^{*} sin ( D ) + {sin ( L )}^{*} {cos ( D )}^{*} cos ( H ) )}$$

$$sin ( β ) = [ {sin ( L )}^{*} sin ( D ) ] - [ {cos ( L )}^{*} {cos ( D )}^{*} cos ( H ) ] ;$$

where, α is the solar azimuth angle; e is the elevation azimuth angle (i.e., the angle between façade normal and true south); L is the latitude (negative for Southern Hemisphere); D is the declination (negative for Southern Hemisphere); and H is the hour angle. The values of L and D are determined by the geographical location, while H is determined by the hour of the day.

The process performed by the processor 120 computes and outputs the discrete values of the direct and diffuse components of the solar radiation. The relation between each global measurement (I₁, I₂, I₃, and I₄) and the direct and diffuse solar radiations as measured by the photosensitive elements 411, 412, 413, and 414 are as follows:

I₁=I₁^{b}+I₁^{d}=I_{b}·cos β·cos γ+I₁^{d}

I₂=I₂^{b}+I₂^{d}=I₂^{d}

I₃=I₃^{b}+I₃^{d}=I_{b}·cos β·cos γ+I₃^{d}

I₄=I₄^{b}+I₄^{d}=I_{b}·sin β+I₄^{d} (1)

where, Iₓ^{b} and Iₓ^{d} x (x=1, 2, 3 or 4) are the direct and diffuse components of solar radiations, respectively, sensed by each of the photosensitive elements; and I_{b}, β, and γ are as defined above.

FIG. 5 shows an exemplary and non-limiting flowchart 500 describing the process for computing discrete values of the direct and diffuse components of the solar radiation according to one embodiment. At S510, the global measurements (I₁, I₂, I₃, and I₄) are received from the sensor 110. In addition, the values of the angles β and γ are received as input. Alternatively, the values of the angles β and γ are computed, for example, as discussed above.

At S520, a check is made to determine if the sun is astronomically positioned in front of the façade to which the sensor 110 is mounted. In one embodiment, S520 includes a check if the value of the angle β is greater than 0° (β>0) and the value of γ is between −90° and 90° (−90<γ<90). If not, at S530, the direct component (I_{direct}) is set to 0 and consequently, I₁^{b}, I₂^{b}, I₃^{b} and I₄^{b} are all 0. In addition, the diffuse component (I_{diffuse}) of the solar radiation perpendicularly projected onto the façade, i.e., the window, is set to I₁. It should be noted that if, from the sensor 110 readings it can be determined that the sun is not seen on the façade, then there is no direct radiation on the façade, hence, I_{b}=I₁^{b}=0. Consequently, the element 411 senses only the diffuse radiation on the façade, i.e. I_{d}=I₁.

If S520 results with a Yes answer, the execution continues with S540 where another check is made to determine if the sky is overcast. Specifically, it is checked if the values I₁, I₂ and I₃ are approximately equal. For example, a difference of up to 5% between the values I₁, I₂ and I₃ will be considered as approximately equal. If so, execution continues with S530; otherwise, execution proceeds to S550.

At S550, the sky's luminous distribution and the proportional diffuse components Iₓ^{d} of Iₓ (x=1, 2, 3, and 4) are computed. There are known techniques in the related art for computing the sky's luminous distribution under the dome of sky using a zenith luminance measurement, which is proportional to the global measurement I₄. In one embodiment, the zenith luminance is normalized to 1, and any location under the dome of sky, particularly locations at elements 411, 412, and 413, can be calculated relative to 1. Specifically, the luminous distribution is the ratio between respective measurements (L₁:L₂:L₃:L₄, where L₄ is 1). Then, the ratio is multiplied by the global measurement I₄ to obtain the diffuse components Iₓ^{d} (x=1, 2, 3, and 4) that fall on each photosensitive element 411, 412, 413, or 414.

At S560, the values of the direct components Iₓ^{b} (x=1, 2, 3, and 4) for each global measurement Iₓ are computed using equation (1) defined above and the diffuse components I₁^{d}:I₂^{d}:I₃^{d}:I₄^{d} computed at S550. At S570, the computed values of the direct and diffuse components are input to the control circuit 130. The computed values may be saved for future use in a memory (not shown). It should be noted that the direct and diffuse components can be computed for either the illuminance or irradiance depending on the type of the photosensitive elements.

FIG. 6 shows an exemplary and non-limiting flowchart 600 describing a process for controlling the window shading system using one or more computed direct and diffuse components. In the embodiment depicted in FIG. 6, the control circuit 130 receives the direct and diffuse illuminance components E₁^{b} and E₁^{d} of the perpendicular solar radiation (as measured by element 411) and computed by the processor 120.

At S610, a direct illuminance threshold value E_{THD} as well as upper bound E_{UPPER} and lower bound E_{LOWER} values of the user-specified lighting levels are set. The E_{THD} value determines a level that is strong enough to cause glare and may be set by a user or according to a preconfigured value. At S620, a check is made to determine if the sun shines directly in front of the façade. That is, if the direct illuminance value E₁^{b} is greater than the threshold value E_{THD}. If so, at S625, the blind/shade of the window shading system 150 is deployed to a level that blocks direct sun at the specified depth into the room. That is, the deployment level (H_{S}) of the window shading system is set to H_{THD} which is a percentage value (0-100%) of a window area that would be occluded due to the deployment operation.

At S630, the resulting daylight level E_{TASK} at a task surface (e.g., a desk) is estimated. In one embodiment, the estimation is performed using a function ƒ( ) for predicting interior horizontal illuminance on the task surface using the values of E₁^{b} and E₁^{d}, H_{S}, and θ_{S}. The parameter θ_{S} is the slat angle that controls blind occlusion (if a venetian blind instead of a shade is used). That is,

E_{TASK}=ƒ(E₁^{b},E₁^{d},H_{S},θ_{S})

At S635, a check is made to determine if the resulting task lighting exceeds the upper boundaries of the user-defined lighting level, i.e., E_{TASK}>E_{UPPER}. If S635 results with a negative answer execution continues with S660; otherwise, at S640, another check is made to determine if the shade/blind is fully deployed, that is, if H_{S}=100% (where, 0% is fully retracted and 100% is fully deployed). If so, execution continues with S645; otherwise, at S650, the shade/blind deployment level H_{S} is lowered by a predefined increment (e.g., 10%). Then, execution continues with S690.

Optionally and also when the blinds are of a venetian type, at S645, it is determined if the slats are completely closed, i.e., if θ_{S}=100% (i.e., the slat angle is 90°) where a 0% slat angle is fully opened (i.e., the slat angle is at 0°) and a 100% slat angle is fully occluded (i.e., the slat angle is at 90°). If the slat angle is different than 100%, then at S655, the blinds are closed by a predefined increment, e.g., 5%. Otherwise, execution continues with S690.

If S635 results with a No answer, then at S660 a check is made to determine if the resulting task lighting is below a lower boundary of the user-specified lighting level, i.e., if E_{TASK}<E_{LOWER}. If S660 results with a No answer execution returns to S620; otherwise, at S665, another check is made to determine if the shade/blind is fully retracted, that is, if H_{S}=0%. If so, execution continues with S670; otherwise, at S675, the shade/blind deployment level H_{S} is retracted by a predefined increment, e.g., the value H_{S} is decremented by 10%.

Optionally and also when the blinds are of a venetian type, at S670, it is determined if the slats are completely opened, i.e., if θ_{S}=0%. If not, at S680, the blinds are opened by predefined increment, e.g., incrementing θ_{S} by 5%. Otherwise, execution continues with S690.

At S690, it is checked if at least one exit condition is satisfied. An example for such a condition may be, for example, if it is nighttime, if the room is vacant, and the like. If the process should end, execution terminates; otherwise, at S695, the controller waits a predefined time period and returns to S630 where another iteration is performed.

The various embodiments disclosed herein can be implemented as hardware, firmware, software or any combination thereof. Moreover, the software is preferably implemented as an application program tangibly embodied on a program storage unit, a non-transitory computer readable medium, or a non-transitory machine-readable storage medium that can be in a form of a digital circuit, an analog circuit, a magnetic medium, or combination thereof. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

While several embodiments have been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

1. A window shading control system, comprising:
a sensor configured to produce a global radiation measurement for each direction of at least four directions, wherein each global radiation measurement is a combined direct and diffuse component of at least one of illuminance and irradiance;
a processor connected to the sensor and configured to compute a discrete direct component and a diffuse component for global radiation measurement; and
a control circuit connected to the processor and configured to control a window shading system based on the discrete direct component and the diffuse component computed for at least one global radiation measurement.

2. The system of claim 1, further comprising:
a driver connected to the window shading system and configured to power and generate control signals for the window shading system.

3. The system of claim 2, wherein the sensor comprises:
a plurality of photosensitive elements;
a housing for at least enclosing the plurality of the photosensitive elements; and
a plurality of reflection blockers configured to block radiation and light from the plurality of photosensitive elements.

4. The system of claim 3, wherein each of the plurality photosensitive elements is configured to measure any one of the combined direct and diffuse component of the illuminance and the combined direct and diffuse component of the of irradiance.

5. The system of claim 3, wherein the sensor is mounted on a façade and the plurality photosensitive elements are positioned to provide measurements perpendicular to the façade; horizontal to the façade; and vertical to the façade.

6. The system of claim 4, wherein the processor is configured to measure and compute the discrete direct component and the diffuse component for global radiation measurement by:
computing a solar altitude angle and a solar elevation azimuth angle;
checking if the sun is astronomically positioned in front of the façade using the value of the solar altitude angle and the solar elevation azimuth angle;
setting the direct component to 0 and the diffuse component is set to I₁, when the sun is not astronomically positioned in front of the façade;
checking if the sky is overcast, when the sun is astronomically positioned in front of the façade;
computing luminous distribution of the sky to result in the diffuse components for the global radiation measurements; and
computing the direct components for the global radiation measurements using the computed diffuse components, the solar altitude angle, and the solar elevation azimuth angle.

7. The system of claim 1, wherein the control circuit is configured to control the window shading system by:
periodically estimating task lighting conditions based on the discrete direct component and the diffuse component computed for at least one global radiation measurement, a deployment level of the shade and a slate angle of the blind of the window shading system; and
incrementally changing at least one of the deployment level of the shade and the slate angle of the blind to meet the estimated task lighting conditions.

8. The system of claim 1, wherein the control circuit is further configured to:
check if the sun shines directly in front of the façade; and
deploy the shade of the window shading system to a level that blocks direct sun at a specified depth into a room.

9. A method for controlling a window shading system, comprising:
measuring a global radiation measurement for each direction of at least four directions, wherein each global radiation measurement is a combined direct and diffuse component of at least one of illuminance and irradiance;
computing a discrete direct component and a diffuse component for the global radiation measurement; and
controlling a window shading system based on the discrete direct component and the diffuse component computed for at least one global radiation measurement.

10. The method of claim 9, wherein measuring the global radiation measurement for each direction further comprises:
measuring any one of the combined direct and diffuse component of the illuminance and the combined direct and diffuse component of the of irradiance.

11. The method of claim 10, wherein the directions of the global measurements are perpendicular to the façade; horizontal to the façade; and vertical to the façade.

12. The method of claim 11, further comprising:
computing a solar altitude angle and a solar elevation azimuth angle;
checking if the sun is astronomically positioned in front of the façade using the value of the solar altitude angle and the solar elevation azimuth angle;
setting the direct component to 0 and the diffuse component is set to I₁, when the sun is not astronomically positioned in front of the façade;
checking if the sky is overcast, when the sun is astronomically positioned in front of the façade;
computing luminous distribution of the sky to result in the diffuse components for the global radiation measurements; and
computing the direct components for the global radiation measurements using the computed diffuse components, the solar altitude angle, and the solar elevation azimuth angle.

13. The method of claim 9, wherein the controlling the window shading system further comprises:
periodically estimating task lighting conditions based on the discrete direct component and the diffuse component computed for at least one global radiation measurement, a deployment level of the shade and a slate angle of the blind of the window shading system; and
incrementally changing at least one of the deployment level of the shade and the slate angle of the blind to meet the estimated task lighting conditions.

14. The method of claim 13, further comprising:
checking if the sun shines directly in front of the façade; and
deploying the shade of the window shading system to a level that blocks direct sun at a specified depth into a room.

15. (canceled)

16. A non-transitory computer readable medium having stored thereon instructions for causing one or more processing units to execute the computerized method according to claim 9.
